(19) United States
(12) Patent Application Publication
(10) Pub. No.: US 2017/0017375 A1
(43) Pub. Date: Jan. 19, 2017

(54) DEVICE AND METHOD FOR DISPLAY DYNAMIC STATUS

(71) Applicant: BROTHER INTERNATIONAL CORPORATION, Bridgewater, NJ (US)

(72) Inventor: Raul George PALACIOS, Apopka, FL (US)

(73) Assignee: BROTHER INTERNATIONAL CORPORATION, Bridgewater, NJ (US)

(21) Appl. No.: 14/799,775

(22) Filed: Jul. 15, 2015

(51) Int. Cl. G06F 3/0481; H04N 1/00; G06F 3/0482

(52) U.S. Cl. CPC G06F 3/04817; G06F 3/0482; H04N 1/00384; H04N 1/00408; H04N 1/00474; H04N 1/00477

(57) ABSTRACT

A user interface of a printer comprise an operation key portion including a plurality of operation keys; and a display that displays a plurality of icons, each associated with a function of the printer. The display further displays dynamic information within the proximity of an icon selected by a user, the dynamic information including a real-time status of the function associated with the selected icon.

### FIELD OF THE INVENTION

The present application generally relates to a display device and method for dynamically displaying device status. Specifically, the present application relates to a device and method for dynamically displaying the status of a printer.

### BACKGROUND

Traditionally, the functions of a printer are very limited, which do not require a dedicated user interface for setting up parameters of the printer. But, modern printers have the capability of printing on different types of mediums, connecting with a variety of networks, and even storing data. Thus, it is a common practice of the current industry to add a user interface to a printer to assist a user to control and monitor the status of a printer.

The current user interface of a printer still does not efficiently assist a user to control or monitor the status of a printer. For example, the printer operator would have to navigate the printer's menu system in order to retrieve specific details of the printer's status conditions. When icons are used to indicate the status of the product, the operator is required to learn how to navigate the printer's menu system and learn the meaning of the various icons. This situation becomes more crucial if there is an error condition and the operator has to resolve the problem and does not know the definitions of those icons.

### SUMMARY OF THE INVENTION

Various embodiments as set forth in the present application satisfy the need for a more efficient printer user interface by providing a printer user interface that dynamically displays the status and information of the printer. The present application reduces the menu navigation when an operator learns the meaning of the icons by automatically displaying relevant information within the proximity of an icon.

An aspect of the present application is directed to a user interface of a printer. The interface comprises an operation key portion including a plurality of operation keys; and a display that displays a plurality of icons, each associated with a function of the printer. The display further displays dynamic information within the proximity of an icon selected by a user, the dynamic information including a real-time status of the function associated with the selected icon.

According to an embodiment, the printer is a thermal printer.

According to another embodiment, the dynamic information includes textual descriptions.

According to yet another embodiment, the dynamic information includes a graphical symbol overlaid on top of the selected icon.

According to various embodiments, the plurality of icons includes an icon indicating a wireless connection, an icon indicating a USB connection, an icon indicating a short range communication connection, an icon indicating the status of an ink, and an icon indicating a status of a printer medium.

### BRIEF DESCRIPTION OF THE DRAWINGS

The accompanying drawings are provided to illustrate embodiments of this disclosure, and, together with the detailed description, serve to explain principles of embodiments as set forth in the present application, in which:

FIG. 1 illustrates a printing system according to an embodiment of the present application.

FIG. 2 illustrates a printing system according to an embodiment of the present application.

FIG. 3 illustrates an example of a printer user interface according to an embodiment of the present application.

FIG. 4 illustrates an example of a printer user interface according to an embodiment of the present application.

FIG. 5 illustrates a mobile printer having a user interface according to an embodiment of the present application.

### DETAILED DESCRIPTION

It will be appreciated by those ordinarily skilled in the art that the foregoing brief description and the following detailed description are exemplary (i.e., illustrative) and explanatory of the subject matter as set forth in the present application, but are not intended to be restrictive thereof or limiting of the advantages that can be achieved by the present application in various implementations. Additionally, it is understood that the foregoing summary and ensuing detailed description are representative of some embodiments as set forth in the present application, and are neither representative nor inclusive of all subject matter and embodiments within the scope as set forth in the present application.

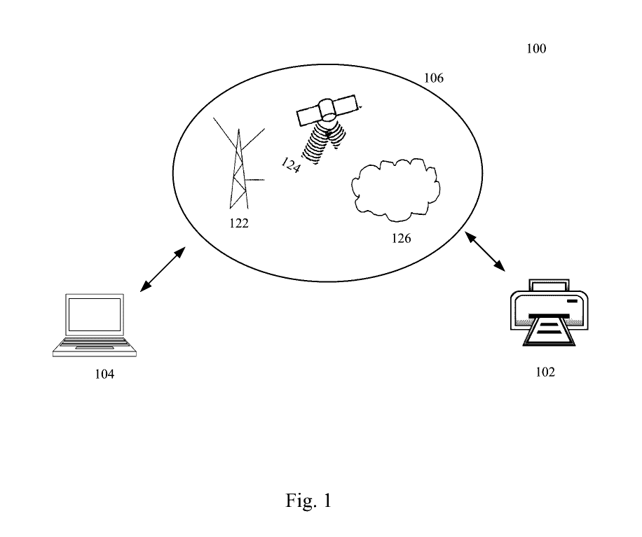

FIG. 1 illustrates a printing system according to an embodiment of the present application. The printing system 100 is used by an electronic device 104 for printing jobs. As shown in FIG. 1, the printing system 100 includes a communication network 102, an electronic device 104, and a printer 102. The printer 102 and the electronic device are connected with each other via the communication network 102.

The communication network 102 should be broadly construed to include any one or more of a number of types of networks that may be created between devices using an internet connection, a LAN/WAN connection, a telephone connection, a wireless connection, a short message system (SMS), a satellite connection, and so forth. According to an embodiment, the communication network 102 includes at least a cellular network 122, a satellite network 124, and a computer network 126, such as the Internet. The computer network 126 may comprise various configurations and protocols including the internet, World Wide Web, intranets, virtual private networks, wide area networks, local networks, private networks using communication protocols proprietary to one or more companies, Ethernet, WiFi and HTTP, cloud and cloud based services, and various combinations of the foregoing. Such communication may be facilitated by any device capable of transmitting data to and from other computers, such as modems (e.g., dial-up, cable or fiber optic) and wireless interfaces.

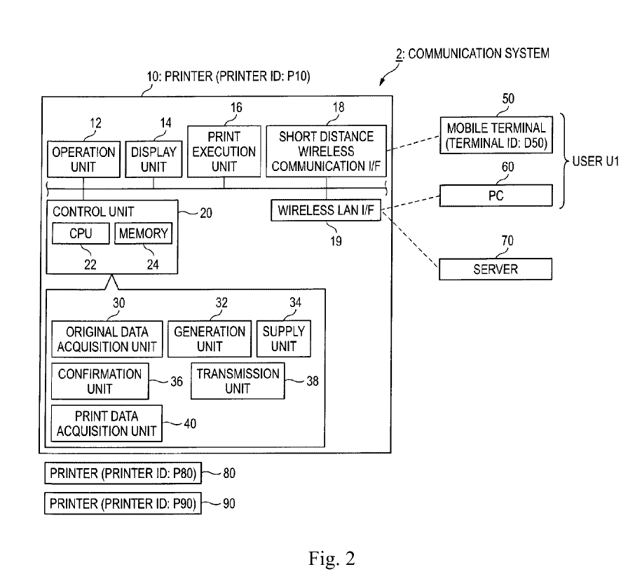

FIG. 2 illustrates a printing system according to an embodiment of the present application. The communication system 2 includes printers 10, 80, 90, a mobile terminal 50, a PC 60 and a server 70. The printers 10, 80, 90 have the same configuration and are peripheral devices of the mobile terminal 50 and the PC 60. The mobile terminal 50 and the PC 60 are used by a specific user U1. The mobile terminal 50 includes a smart phone, a PDA terminal, a laptop PC, a tablet PC and the like, for example.

The printers 10, 80, 90 and the mobile terminal 50 can perform communication with each other by short distance wireless communication (for example, Bluetooth (registered trademark)). According to an embodiment, the communication interface may also be implemented when infrared communication or NFC (Near Field Communication) is used. In a printing operation, the user U1 brings the mobile terminal 50 close to the printer 10 to thus perform the short distance wireless communication between the mobile terminal 50 and the printer 10. When a distance between the printer 10 and the mobile terminal 50 is within a predetermined distance, the printer 10 and the mobile terminal 50 can perform the short distance wireless communication.

The PC 60 has a structure similar with a general computer that includes a CPU, a memory, a display and the like, which are not shown. The memory of the PC 60 stores therein a printer driver program for the printer 10. The CPU of the PC 60 uses the printer driver program to thus generate PDL (Page Description Language) data that is data of a print target. The server 70, like the PC 60, includes a CPU, a memory and the like, which are not shown. The server 70 is configured to acquire print data from the printer 10 and temporarily store the print data therein. When a plurality of users share the printers 10, 80, and 90, the server 70 is used to manage the printing requests sent by the plurality of users.

The printers 10, 80, 90, the PC 60 and the server 70 can perform communication with each other through a wireless LAN or perform the short distance wireless communication. According to another embodiment, the printers 10, 80, 90, the PC 60 and the server 70 may perform communication with each other through a wired LAN or connected directly via cables.

The printers 10, 80, 90 have printer IDs ‘P10’, ‘P80’ and ‘P90’, respectively, and the mobile terminal 50 has a terminal ID ‘D50.’ The printer IDs and the terminal ID are unique IDs and may be IDs (node names, user names and the like) designated by a user or may be predetermined IDs (MAC addresses and the like).

As shown in FIG. 2, the printer 10 includes an operation unit 12, a display unit 14, a print execution unit 16, a short distance wireless interface 18, a wireless LAN interface 19 and a control unit 20. The short distance wireless interface 18 is an interface that is used when the control unit 20 performs the short distance wireless communication. The wireless LAN interface 19 is an interface that is used when the control unit 20 uses typical wireless communication (for example, wireless communication based on IEEE802.1 and the like) through the wireless LAN. The operation unit 12 includes a plurality of keys. A user can input a variety of instructions into the printer 10 through the operation unit 12. The display unit 14 is a display for displaying a variety of information. The print execution unit 16 has a print mechanism such as inkjet, laser methods, or a thermal printing head, and is configured to execute a printing operation in response to an instruction from the control unit 20. The respective units 12 to 20 are connected to a bus line (a reference numeral thereof is omitted). According to an embodiment, the printer 10 represents a portable thermal printer or a stationary thermal printer.

The control unit 20 includes a CPU 22 and a memory 24. The CPU 22 is configured to execute a variety of processing instructions in response to programs and firmware stored in the memory 24. The memory 24, which is non-transitory, is configured by a ROM, a RAM, a hard disk and the like. The memory 24 is configured to store the programs that are executed by the CPU 22 and data that is acquired or generated while the CPU 22 executes the processing. The CPU 22 is configured to execute the processing in response to the programs, so as to implement respective functions of an original data acquisition unit 30, a generation unit 32, a supply unit 34, a confirmation unit 36, a transmission unit 38 and a print data acquisition unit 40.

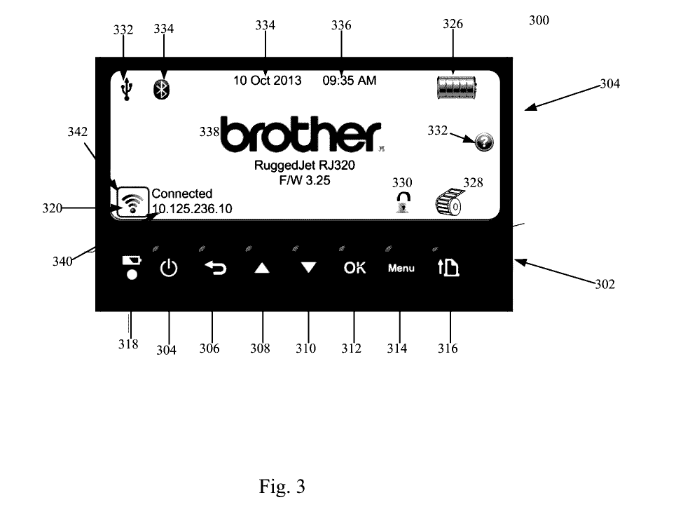

FIG. 3 shows a user interface of a printer according to an embodiment of the present application. The user interface 300 includes an operation portion 302 and a display 304. The display 304 displays a plurality of icons showing the functions and status of the printer. The operation portion 302 is used to accept the input from a user to check status of the printer or execute a function of the printer.

The operation portion 302 includes a plurality of operation keys 304-318. The operation key 304 is used to turn on and off the printer. The operation key 306 is used to select a submenu associated with an icon. The arrow keys 308 and 310 are used to move a highlighted area shown in the display 304 among the plurality of icons and menus. For example, the highlighted area may be marked by a frame 342. The operation key 312 is used to execute a function of the printer. The operation key 314 is used to display the main menu of the printer. The operation key 316 is used when a printing medium needs to be handled. The key 318 represents an indicator that indicates a status of a battery.

The display 304 displays a plurality of icons 320-332, each associated with a function of the printer. The icon 320 represents a status of a wireless connection. The icon 322 represents a status of a USB connection. The icon 324 represents a status of a short range connection such as Bluetooth. The icon 326 represents a status of an ink cartridge. The icon 332 is used to display a help menu. The icon 328 represents a status of the printer medium. The icon 330 represents whether the user interface is locked or not. Each of the icons is associated with a plurality of submenus and functions that need to be learned and controlled by a printer user. Thus, the user interface as shown in FIG. 3 represents a main menu of the user interface that further includes a plurality of submenu arranged in a hierarchical structure.

A conventional user interface of a printer does not display additional information of the icon on the main menu. A printer operator needs to study the menu and goes through all the submenus to learn how to use the user interface. The embodiments as set forth in the present application configures the user interface 300 to display a plurality of information 334-340 about the printer in addition to the plurality of icons. The plurality of information includes date 334, time 336, maker and model 338, and status information 340 of an icon. According to an embodiment, the status information 340 is automatically updated and displayed when a user uses the arrow keys to highlight an icon. According to an embodiment, the user interface 300 displays a box 342 around an icon to highlight that icon when a user navigates icons by using those arrow keys. When the wireless connection icon 320 is highlighted, the connection status is checked in real-time and the status is displayed as the information 340, which states “Connected, 10.125.236.10.” This dynamic information 340 provides instant feedback to the user, who does not need to go to the submenu to obtain the details. The dynamic information 340 also includes key information associated with the function. For example, for a wireless connection, the dynamic status information not only shows whether the printer is connected or not but also shows the IP address of the connection. According to an embodiment, the dynamic status information 340 is displayed at a location that is adjacent to the dedicated icon.

According to an embodiment, the user interface can be configured to display a customized logo or symbol as a background. In one example, the make and model icon 338 may be replaced by the customized logo or symbol. In another example, icons and information 320-340 are overlaid on top of the customized logo or symbol. In one embodiment, the customized logo or system represents a name of the company, user, or institution that uses a printer having a user interface as set forth in the present application.

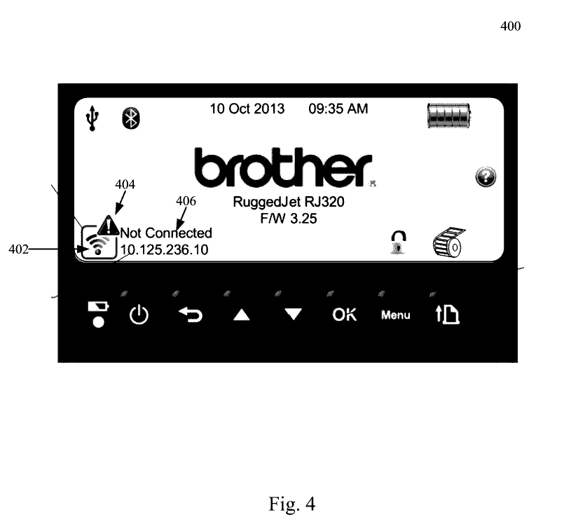

FIG. 4 shows another embodiment of the user interface 300. The icon 402 is dynamically updated when the user highlights this icon. As the printer is not wirelessly connected with a network, the icon 402 includes an additional graphical symbol overlaid on top of the icon 320 to reflect the non-connection status or the error status. Furthermore, the status information is also changed to “Not connected, 10.125.236.10.” Similar dynamic status information may be displayed in association with other icons on the main menu.

According to an embodiment, the dynamic status information associated with an icon is only displayed when the icon is highlight or selected. Dynamic status information of other icons that are not selected or highlighted is not displayed to reduce the distraction of the printer operator. According to an embodiment, the dynamic status information is displayed for all icons regardless whether an icon is selected or not.

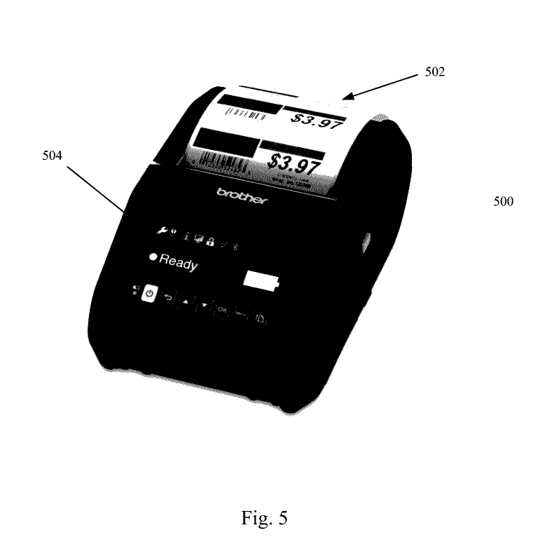

FIG. 5 illustrates a mobile printer having a user interface according to an embodiment of the present application. The printer 500 represents a mobile printer that may be carried by a user to print out labels, receipts, tickets, or tags 502. An example of such a mobile printer is the Brother™ RuggedJet™ 3 Series of mobile label and receipt printers. The printer 500 is capable of being used in a wide range of label and receipt printing applications, including retail, public safety, field service, route accounting, manufacturing and warehouse. The printer 500 has a compact design that allows the printers to fit in places where space is limited, and optional accessories are available for carrying in the field and fast charging. In one embodiment, the printer 500 is designed to sustain an impact of up to 6 feet. In one embodiment, the weight of the printer 500 is less than 2 pounds. In one embodiment, the sizes of the printer 500 are no more than a few inches in each dimension.

According to one embodiment, the mobile printer uses a direct thermal printing technology, which provides several benefits. For example, the printer has lower maintenance costs and higher reliability than many other printing technologies due to fewer moving parts; the printer also has low consumable costs and quiet printing characteristic because no ink or ribbons are used or to be replaced; and the printer also has the ability to be used in just about any orientation. In one embodiment, the labels and receipts 502 are made of thermal paper and synthetic materials, with output sizes from 1 inch to 3 inches wide to meet a wide range of market applications.

In another embodiment, the printer 500 includes a user interface 504 as set forth in the present application to assist a user to operate the printer. As the user interface 504 uses dynamically updated icons and status messages, it is easy for the user to understand the functions and status of the printer.

The phrase “an embodiment” as used herein does not necessarily refer to the same embodiment, though it may. In addition, the meaning of “a,” “an,” and “the” comprise plural references; thus, for example, “an embodiment” is not limited to a single embodiment but refers to one or more embodiments. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like.

While this invention has been described in conjunction with the specific embodiments outlined above, it is evident that many alternatives, modifications, and variations will be apparent to those ordinarily skilled in the art. Accordingly, the preferred embodiments of the invention as set forth above are intended to be illustrative, not limiting. Various changes may be made without departing from the spirit and scope of the inventions as defined in the following claims.

What is claimed is:

1. A user interface of a printer, the user interface comprising:
an operation key portion including a plurality of operation keys; and
a display that displays a plurality of icons, each associated with a function of the printer,
wherein the display further displays dynamic information within the proximity of an icon selected by a user, the dynamic information including a real-time status of the function associated with the selected icon.

2. The user interface of claim 1, wherein the printer is a thermal printer.

3. The user interface of claim 1, wherein the dynamic information includes textual descriptions.

4. The user interface of claim 3, wherein the dynamic information includes a graphical symbol overlaid on top of the selected icon.

5. The user interface of claim 1, wherein the plurality of icons includes an icon indicating a wireless connection, an icon indicating a USB connection, an icon indicating a short range communication connection, an icon indicating the status of an ink cartridge, and an icon indicating a status of a printer medium.
